(19) United States
(12) Patent Application Publication
(10) Pub. No.: US 2002/0024474 A1
(43) Pub. Date: Feb. 28, 2002

(54) Planar sleeve dipole antenna

(76) Inventor: Tai-Lee Chen, Taipei (TW)

Correspondence Address: JACOBSON HOLMAN PLLC, 400 SEVENTH STREET N.W., SUITE 600, WASHINGTON, DC, 20004, US

(21) Appl. No.: 09/899,042

(22) Filed: Jul. 6, 2001

(30) Foreign Application Priority Data
Aug. 31, 2000 (TW) 089117959

(51) Int. Cl. H01Q 9/04; H01Q 9/16

(52) U.S. Cl. 343/792; 343/790

(57) ABSTRACT

A planar sleeve dipole antenna compromises a dielectric substrate with conductive circuits on both sides. Upper circuits include an upper conductive area of the signal feeding microstrip line and its extended conductive area, bottom circuitry includes a lower ground conductor of microstrip line and its two extended conductive areas. Signals are fed from the end of microstrip line, by means of the 1/4 wavelength upper conductive area and the bottom 1/4 wavelength extended conductive area to form a half wavelength oscillating dipole to achieve radiation.

### BACKGROUND OF THE INVENTION

I. Field of the Invention

This invention relates generally to a planar antenna and, more specifically, to a sleeve dipole antenna that offers a planar antenna. The input method reduces a lot of space needed by the known T type dipole antenna. The symmetry structure is easier for impedance match with the known microstrip, coaxial cable, and easier to connect with following circuits. The symmetry structure also maintains the radiative field keeping balance; this scheme benefits the design requirement of the H-plane omni-direction. The substrate of the present invention is not limited to special material.

II. Description of the Prior Art

A known sleeve dipole antenna, as shown in FIG. 1, is composed of coaxial cable 11, 12, 14 and a surrounding ground conductor 15. A center conductor part 13 protruding the coaxial cable is about ¼ wavelength. The surrounding ground conductor 15 stretches backward about ¼ wavelength and looks like a folded back sleeve; and with the center part 13 form a half wavelength dipole resonate mechanism to radiate energy.

Another known printed circuit dipole antenna (Yu-De Lin et al., 1998, Analysis and design of broadside-coupled-striplines fed bow-tie antennas” IEEE Trans. Antennas Propagate., vol. 46, no. 3, pp 459-460), as shown in FIG. 2, is fulfilled on a substrate 26, which includes conductive stripe 23 extending from a microstrip 21, 22, 24, and a ground conductor 25 in opposite direction to form a half wavelength dipole resonate mechanism. The antenna parts 23, 25 and the feeding microstrip 21, 22, 24 are in T shape.

Another known printed circuit dipole antenna (U.S. Pat. No. 5,598,174) as shown in FIG. 3, which is fulfilled on a substrate 36, includes the center strip 33 extending from the feeding microstrip 31, 32, 34 and a ground conductor strip 35 to achieve half wavelength resonate mechanism. The structure is not symmetry to the axis as the sleeve dipole antenna, therefore it is not so easy to match impedance with the connecting microstrip or coaxial cable. The H-plane radiation pattern is also not so omni-directional as the sleeve dipole antenna.

### SUMMARY OF THE INVENTION

It is therefore a primary object of the invention to provide a planar sleeve dipole antenna that can be made from printed circuit board to reduce the cost and available for mass production.

It is another object of the invention to provide a planar sleeve dipole antenna that changes the known sleeve dipole antenna's structure to flat shape to reduce the physical size.

It is another object of the invention to provide a planar sleeve dipole antenna that is symmetry in right and left direction so that it is easier to connect and for impedance match with the coaxial cable, microstrip, CPW, and other planner circuits.

It is another object of the invention to provide a planar sleeve dipole antenna that is symmetry in right and left direction so that the radiated energy suits the application of the H-plane omni-direction antenna.

In order to achieve the objective set forth, a planar sleeve dipole antenna in accordance with the present invention comprises a dielectric substrate with conductive circuits on both sides. Upper circuits include an upper conductive area of the feeding microstrip line and its extended conductive area, bottom circuits include a lower ground conductor of microstrip line and its two extended conductive areas. Signals are input from the end of microstrip line, by means of the ¼ wavelength upper conductive area and the bottom ¼ wavelength extended conductive area to form a half wavelength oscillating dipole to achieve radiation.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a diagram of the known sleeve dipole antenna;

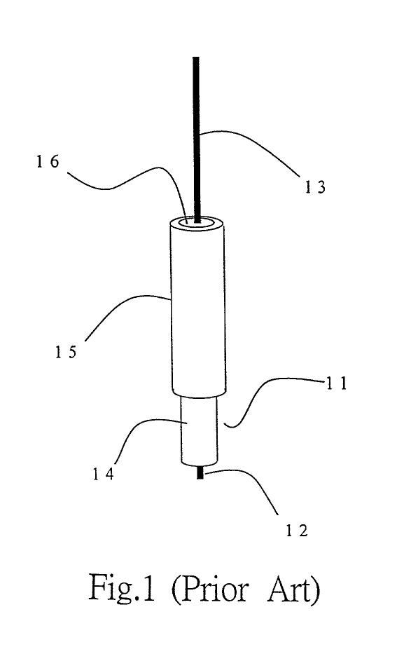

FIG. 2 is a diagram of the known printed dipole antenna;

FIG. 3 is a diagram of another known printed dipole antenna;

FIG. 4 is an application diagram of the present invention;

FIG. 5 is another application diagram of the present invention;

FIG. 6 is the H-plane omni-direction radiation chart of the present invention.

### DESCRIPTION OF THE PREFERRED EMBODIMENT

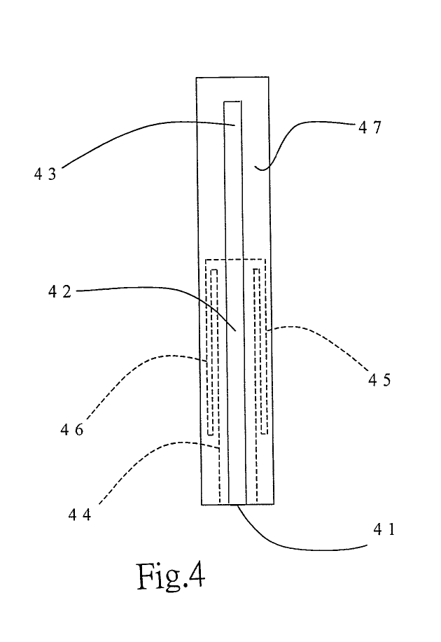

Referring to FIG. 4, the present invention is composed of a substrate 47 with conductive circuits on both sides. The material of the substrate is not limited to special items. Signals are fed from the end of microstrip line 41 and transmitted through the microstrip line of the upper conductive area 42 and lower ground conductor 44. The other end of the upper conductive area 42 connects to a ¼ wavelength extended conductive area 43. The other end of the lower ground conductor 44 connects separately to two ¼ wavelength extended conductive area 45, 46. The lower ground conductor 44 overlaps with the upper conductive area 42 and is equal or wider than the upper conductive area 42 in physical size. This arrangement allows the lower ground conductor 44 to transfer energy in guided mode. The extended conductive area 45, 46 spread in both side of the lower ground conductor 44 in folded back way. They connect to the lower ground conductor 44 only on top portion, and the rest of their area is separate with the lower ground conductor 44 by narrow slot. The current distribution of the extended conductive area 45, 46 is in opposite phase with the lower ground conductor 44 and form a half wavelength oscillation mechanism with the current distribution of extended conductive area 43, such arrangement can achieve radiation.

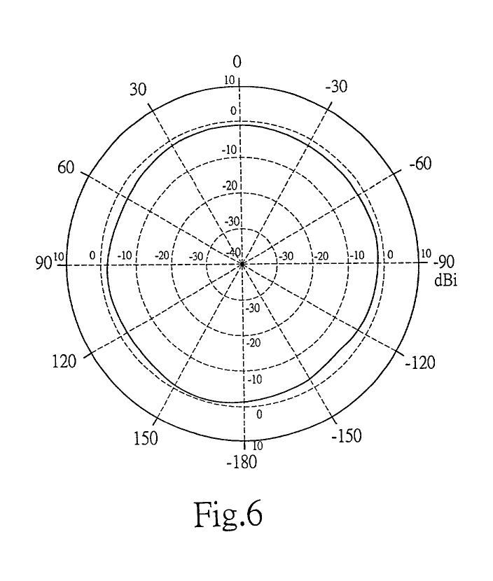

An application example of present invention as following: the typical frequency designed is ISM band 2.4˜2.5 GHz. The substrate 47 is FR-4 type PCB with 0.8 mm thickness. The upper extended conductive area 43 is 20 mm in length, the bottom extended conductive area 45, 46 also are 20 mm long and 6 mm in width. The H-plane measurement result, referring to FIG. 6, shows its omni-direction characteristic with gain about OdBi.

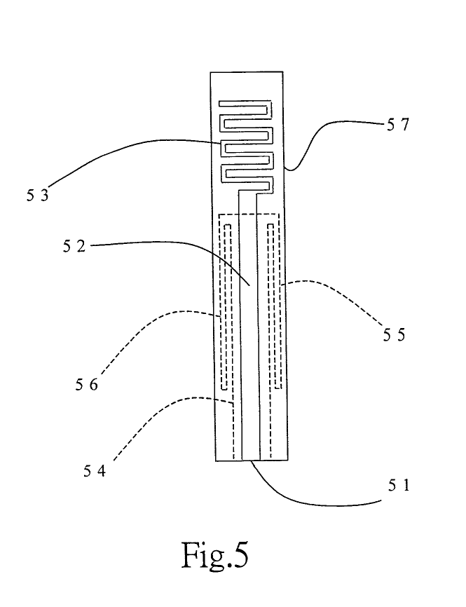

A second application example of present invention, referring to FIG. 5, the structure is composed of a substrate 57 and two conductive circuits on top and bottom respectively. The material of the substrate is not limited to special items. The functions of the upper conductive area 52, the extended conductive area 53, the lower ground conductor 54 and the lower extended conductive area 55, 56 are same as the upper conductive area 42, the extended conductive area 43, the lower ground conductor 44 and the extended conductive area 45, 46. The extended conductive area 53 in this example is in meander shape to decrease the antenna size and increase the horizontal field. The extended conductive area 43, 53 can be in other shapes as long as they keep the ¼ wavelength rule.

The major advantages of above application examples of the present invention over the know prior art as following:

1. The present invention changes the known coaxial sleeve dipole antenna to flat shape and suitable for general application, and also reduce the needs of mechanical design.

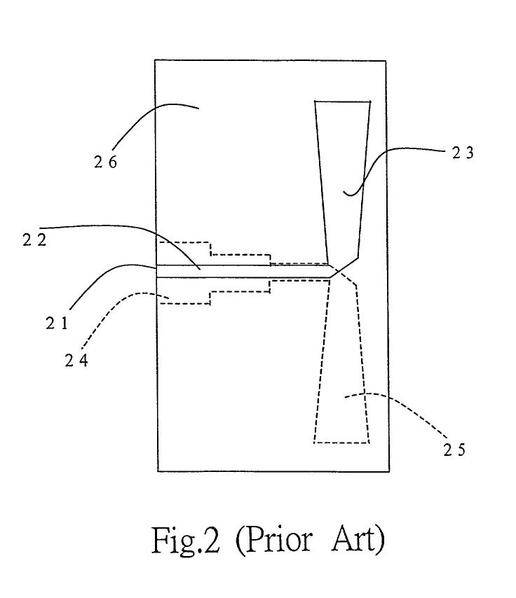

2. The present invention is the same printed circuit dipole antenna as the prior art in FIG. 2, however the present invention needs less physical area that reduce the circuit cost, and gives more flexibility of appearance design.

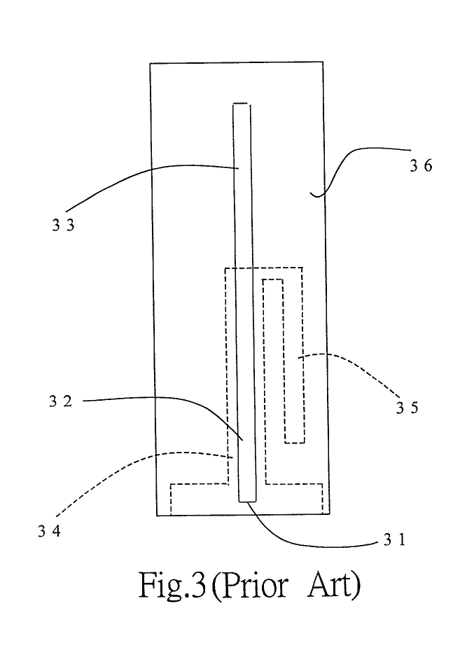

3. The present invention is the same printed circuit dipole antenna as the prior art in FIG. 3, however the present invention applies the extended conductive area 45, 46 in symmetry that makes the current flow to ground symmetrically in right and left two directions. With the extended conductive area 43, they generate half wavelength oscillation that makes the radiation field more symmetry; such scheme has better result for H-plane omni-direction. It also gets better input-impedance match and connection with the right to left symmetry devices such as microstrip line, coaxial cable and coplanar waveguide.

By above two examples, the present invention is easy to manufacture and in lower cost, therefore it is also available to cellular phone, wireless network and other radio communication equipment. If the present invention is in array applications, it can also achieve higher antenna gain and apply to diversity system, phased array antenna systems.

While a preferred embodiment of the invention has been shown and described in detail, it will be readily understood and appreciated that numerous omissions, changes and additions may be made without departing from the spirit and scope of the invention.

What is claimed is:

1. A planar sleeve dipole antenna comprising:
a substrate with an dielectric material;
microstrip lines on said substrate for feeding signal;
an upper conductive area;
a lower ground conductor;
a ¼ wavelength extended conductive area on the top of said substrate, one end connected to said upper conductive area;
two ¼ wavelength extended conductive areas on the bottom of said substrate, one end of each connected to said lower ground conductor.

2. The planar sleeve dipole antenna recited in claim 1, wherein said ¼ wavelength extended conductive area of said upper conductive area can be in other shapes than long stripe, for example: meander, ladder, triangle, circle, zipper or bow as long as they keep the ¼ wavelength rule.

3. The planar sleeve dipole antenna recited in claim 1, wherein one end of said two ¼ wavelength extended conductive areas of said lower ground conductor connecting to said one end of said lower ground conductor; other area are spread in both side of said lower ground conductor in folded back way with very narrow distance.

4. The planar sleeve dipole antenna recited in claim 1, wherein said lower ground conductor overlapping with said upper conductive area and in equal or wider than said upper conductive area in physical size to transmit energy in guided mode.

5. The planar sleeve dipole antenna recited in claim 1, wherein said two ¼ wavelength extended conductive areas of said lower ground conductor can be in other shapes than long stripe, for example: meander, ladder, triangle, circle, zipper or bow as long as they keep the ¼ wavelength rule.
